(19) United States
(12) Patent Application Publication
(10) Pub. No.: US 2002/0147318 A1
(43) Pub. Date: Oct. 10, 2002

(54) Preparation method of water soluble carboxylmethyl chitosan having anti-lipid peroxidation ability

(76) Inventors: Fu Chuan Cho, Taipei (TW); Fung-Jou Lu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/834,610

(22) Filed: Apr. 16, 2001

(30) Foreign Application Priority Data
Apr. 9, 2001 (CN) 01110671.X

(51) Int. Cl. C08B 37/08

(52) U.S. Cl. 536/20

(57) ABSTRACT

A preparation method of water soluble carboxylmethyl chitosan (CM chitosan) is proposed to provide anti-lipid peroxidation ability. The water soluble CM chitosan is prepared by special chemical methods from both shrimp's and crab's shells and the molecular weight thereof is between 220-250 Kda and the deacetylated degree thereof is about 92%. The two kinds of CM chitosan derived from shrimp's and crab's shells are powerful antioxidants to prevent lipid peroxidation of rat liver microsome. Their antioxidative abilities are as powerful as that of water soluble form of Trolex (water soluble vitamin E).

### FIELD OF THE INVENTION

The present invention relates to a preparation method of water soluble carboxylmethyl chitosan having anti-lipid peroxidation ability.

### BACKGROUND OF THE INVENTION

The chitosan has been found in wide scope of natural source and is only less abounding to the cellulose. The chitosan can be abstracted from shrimp or crab crusts and has the advantages of biological decomposability, recycled usage, physiological and biological effects. Moreover, the chitosan does not cause environment pollution. The National Science Council, Republic of China had conducted research of deriving chitosan and chitin from the exoskeleton of insects and marine invertebrates since 1996.

The present invention is intended to provide a preparation method of water soluble carboxylmethyl chitosan (CM chitosan) having anti-lipid peroxidation ability. The CM chitosan has excellent antioxidant effect and can be used as food, biomedical material and cosmetic ingredient, and can prevent the liver from the damage of lipid peroxidation.

### SUMMARY OF THE INVENTION

It is the object of the present invention to provide a preparation method of water soluble carboxylmethyl chitosan having anti-lipid peroxidation ability.

The water soluble CM chitosan is prepared by special chemical methods from both shrimp's and crab's shells and the molecular weight thereof is between 220-250 Kilodalton (Kda). The two kinds of CM chitosan derived from shrimp's and crab's shells are powerful antioxidants to prevent lipid peroxidation of rat liver microsome. Their antioxidative abilities are as powerful as that of water soluble form of Trolex (water soluble vitamin E).

The various objects and advantages of the present invention will be more readily understood from the following detailed description when read in conjunction with the appended drawing, in which:

### BRIEF DESCRIPTION OF DRAWING

FIG. 1 shows the anti-lipid peroxidation effect of CM chitosan from shrimp according to the present invention;

FIG. 2 shows the anti-lipid peroxidation effect of CM chitosan from crab according to the present invention;

FIG. 3 shows the anti-lipid peroxidation effect of Trolox;

### DESCRIPTION OF THE INVENTION

### EXAMPLE 1

The Preparation Method of Water Soluble CM Chitosan

(1) The preparation of chitin raw material

The chitin is isolated from shrimp crusts. The shrimp crusts are firstly dried and then dipped in weak basic solution, for example 5% NaOH (sodium hydroxide), with ratio 1:20 (W/V) at room temperature for 20 hours to remove protein from the shrimp crusts. The resulting material is washed by water several times and then dipped in weak acid solution, for example 5% HCl, with ratio 1:20 (W/V) at room temperature for 10 hours to demineralize. The resulting material is washed by water and then dried to obtain chitin raw material.

(2) The preparation of deacetylated chitosan

The thus obtained chitin raw material is pulverized by 0.2 mm mesh then sifted by 40-60 meshes. The sifted chitin raw material is mixed with 50% NaOH by the ratio 1:15 (W/V) at 100° C. for 6 hours with mechanical stirring at 250 rpm. The deacetylated chitosan is washed by water until the deacetylated chitosan is test to be neutralized by cobaltous chloride (Whatman, USA). The deacetylated chitosan is washed by distill water for three times and then dried at 50° C.

(3) The preparation of water soluble carboxylmethyl chitosan (CM chitosan)

The deacetylated chitosan (20 g) is suspended in 400 ml of isopropyl alcohol with stirring, then treated with 50.4 ml of 10M NaOH and stirred by 45 minutes. The resulting solution is added with 24 g monochloracetic acid powder at 50° C. for 6 hours. The mixture is poured into about 35 ml of water. The pH of the resulting solution is adjusted to 7 with glacial acetic acid, and the precipitate is collected by filtration. The obtained solid is washed with 500 ml of 70% methanol and then washed again with methanol. After that, it was dried at 60° C. to give 30 g of the product water soluble carboxylmethyl chitosan (CM chitosan).

The molecular weight of thus obtained water soluble CM chitosan is measure to be 220-250 Kda and the deacetylated degree thereof is about 92%. The water soluble CM chitosan made from shrimp crusts has satisfactory anti-lipid peroxidation effect.

### EXAMPLE 2

Antioxidative Effect on Lipid of Rat Micorsomes by Water soluble CM chitosan made from shrimp crusts.

In the present, the rat microsomes is used to provide lipid source. The product of lipid peroxidation induced by NADPH with heat treatment (deconstructing microsome enzyme) is referred as MDA (malondialdehyde). The MDA is added with TBA (thiobarbituric acid) to form MDA-TBA compound with pink fluorescence. The MDA-TBA compound has absorption spectrum at 535 nm (or 532 nm) wavelength. The content of MDA can be manifested by the absorption degree of light at those wavelengths. Therefore, the degree of lipid peroxidation can also be known. If the content of MDA is decreased after addition of water soluble CM chitosan, the reduction of MDA can be attributed to the water soluble CM chitosan. It means that the water soluble CM chitosan has the ability of anti-lipid peroxidation. In the present invention, the anti-lipid peroxidation ability of the water soluble CM chitosan is compared with that of the Trolex (water soluble vitamin E).

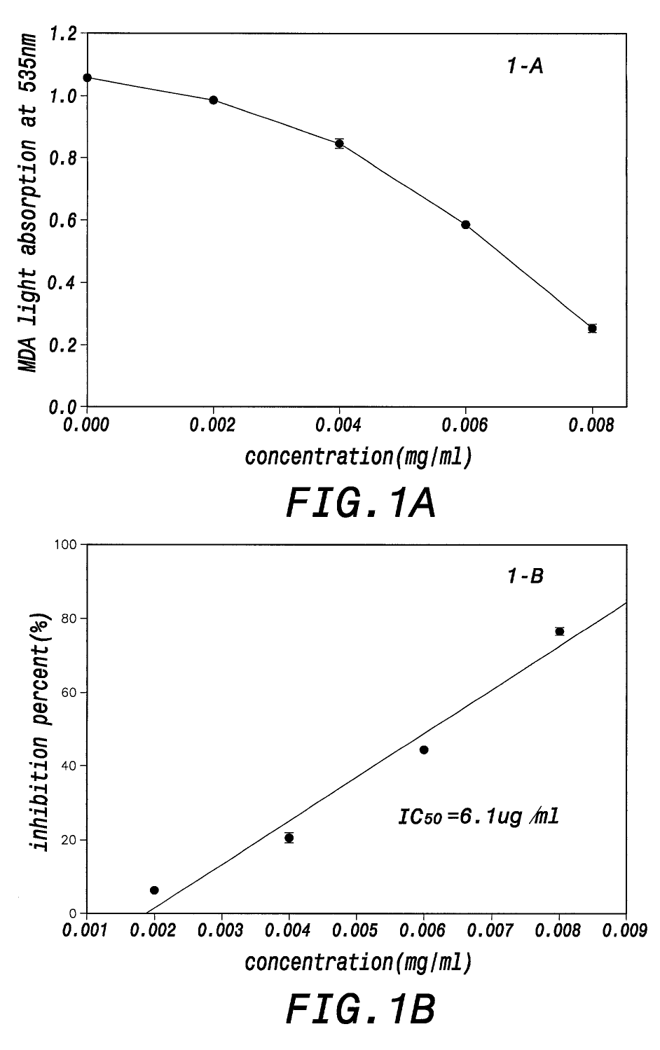

Result 1: FIG. 1 shows the experimental result for antioxidant ability of water soluble CM chitosan in the biological lipid peroxidation system using rat liver microsomes, wherein the water soluble CM chitosan is derived from shrimps.

As can be seen from FIG. 1, the addition of the water soluble CM chitosan derived from shrimps can suppress the lipid peroxidation in rat liver microsomes. The water soluble CM chitosan derived from shrimps has high antioxidant ability.

More particularly, FIG. 1A shows that MDA, the product of lipid peroxidation, is monotonically decreased as the added amount of water soluble CM chitosan derived from shrimps is increased.

FIG. 1B shows that the IC₅₀ (the concentration required to suppress 50% lipid peroxidation) of water soluble CM chitosan derived from shrimps is 6.1 (by taking average over at least three data).

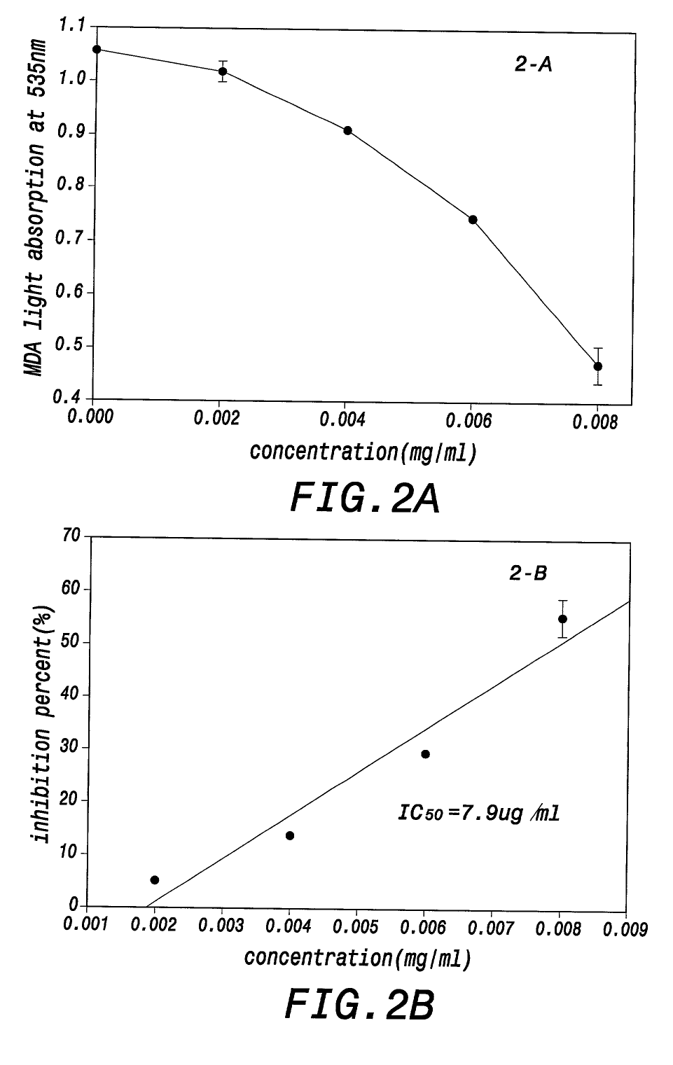

Result 2: FIG. 2 shows the experimental result for antioxidant ability of water soluble CM chitosan in the biological lipid peroxidation system using rat liver microsomes, wherein the water soluble CM chitosan is derived from crabs.

As can be seen from FIG. 2, the addition of the water soluble CM chitosan derived from crabs can suppress the lipid peroxidation in rat liver microsomes. The water soluble CM chitosan derived from crabs has high antioxidant ability.

More particularly, FIG. 2A shows that MDA, the product of lipid peroxidation, is monotonically decreased as the added amount of water soluble CM chitosan derived from crabs is increased.

FIG. 2B shows that the IC₅₀ (the concentration required to suppress 50% lipid peroxidation) of water soluble CM chitosan derived from crabs is 7.9 (by taking average over at least three data).

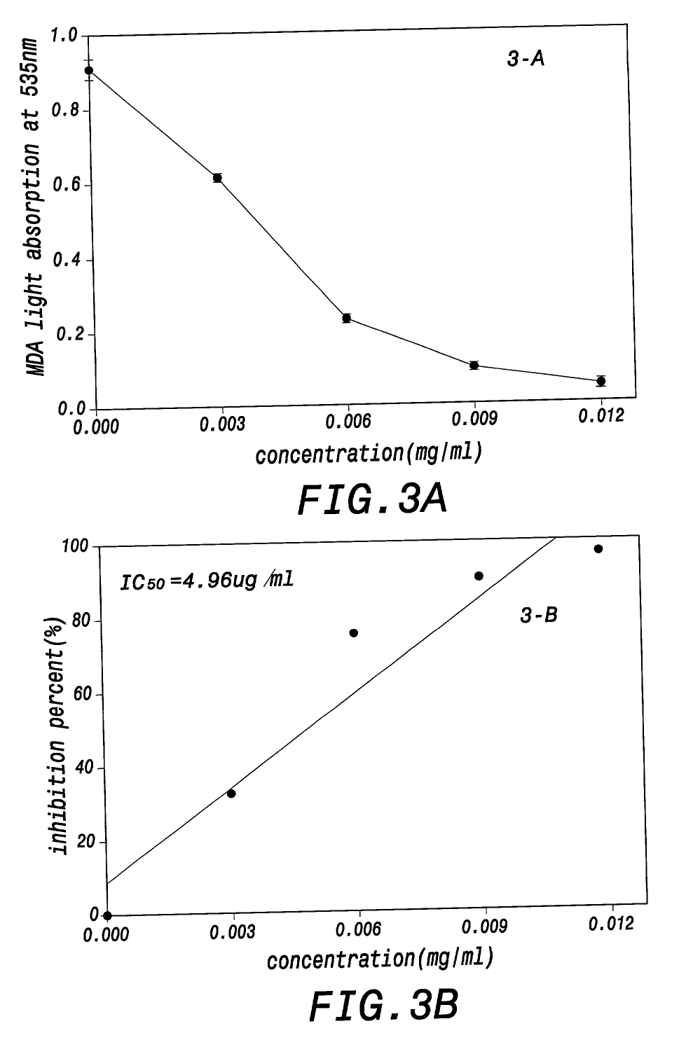

Result 3: FIG. 3 shows the experimental result for antioxidant ability of Trolex (water soluble vitamin E) in the biological lipid peroxidation system using rat liver microsomes.

As can be seen from FIG. 3, the addition of Trolex (water soluble vitamin E) can suppress the lipid peroxidation in rat liver microsomes. The Trolex (water soluble vitamin E) has high antioxidant ability.

More particularly, FIG. 3A shows that MDA, the product of lipid peroxidation, is monotonically decreased as the added amount o Trolex (water soluble vitamin E) is increased.

FIG. 3B shows that the IC₅₀ (the concentration required to suppress 50% lipid peroxidation) of Trolex (water soluble vitamin E) is 4.96 (by taking average over at least three data).

As can be seen from above experimental results, the water soluble CM chitosan derived from shrimps or crabs has high antioxidant ability, which is compatible with that of Trolex (water soluble vitamin E). Their effects are summarized as follows:

(a) The IC₅₀ of Trolex (water soluble vitamin E) is 4.96 μg/ml.

(b) The IC₅₀ of water soluble CM chitosan derived from shrimps is 6.1 μg/ml.

(c) The IC₅₀ of water soluble CM chitosan derived from crabs is 7.9 μg/ml.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A preparation method of water soluble carboxylmethyl chitosan having anti-lipid peroxidation ability, comprising following steps:
(1) the shrimp or crab crusts are treated by basic solution to remove protein therefrom, the resulting material is treated by acid solution to demineralize, thus obtaining chitin raw material;
(2) the chitin raw material is treated in basic solution at 80-100° C. to obtain deacetylated chitosan.
(3) the deacetylated chitosan is dissolved in alcohol to carboxylmethylate, the resulting solution is then dried to obtain carboxylmethyl chitosan (CM chitosan).

2. The preparation method of water soluble carboxylmethyl chitosan as in claim 1, wherein the basic solution in step (1) or step (2) can be selected from the group consisting of NaOH and KOH.

3. The preparation method of water soluble carboxylmethyl chitosan as in claim 1, wherein the acid solution in step (1) can be selected from the group consisting of hydrochloric acid, acetic acid, nitric acid, phosphoric acid, oxalic acid, and butyric acid.

4. The preparation method of water soluble carboxylmethyl chitosan as in claim 1, wherein the alcohol in step (3) can be selected from the group consisting of isopropyl alcohol and isobutyl alcohol.
